(19) United States
(12) Patent Application Publication
(10) Pub. No.: US 2012/0128921 A1
(43) Pub. Date: May 24, 2012

(54) HIGH-TEMPERATURE SEALING

(75) Inventors: Patrick Seitz, St. Peter-Freienstein (AT); Bernhard Fluch, Baden (AT); Stefan Pischek, Honigsberg (AT); Margareta Bugajski, Villach (AT)

(73) Assignee: REFRACTORY INTELLECTUAL PROPERTY GMBH & CO. KG, Wien (AT)

(21) Appl. No.: 13/388,897

(22) PCT Filed: Apr. 16, 2011
(86) PCT No.: PCT/EP2011/001943

§ 371 Date: Feb. 3, 2012

(30) Foreign Application Priority Data
Jun. 8, 2010 (EP) 10 005 873.4

(51) Int. Cl. B32B 3/02

(52) U.S. Cl. 428/76

(57) ABSTRACT

The invention relates to a high temperature sealing, including the following features:
a ceramic refractory sealing mass,
an envelope surrounding the said refractory sealing mass,
the envelope decomposes at temperatures between >50 and <2.000° C. and
forms a carbon layer, after its decomposition, along the surface of the ceramic sealing mass.

The invention relates to a sealing for high temperature applications.

The inventive concept is especially directed towards a sealing and a sealing material, which may be used for sealing (to seal) refractory ceramic construction elements (workpieces) or as a scaling between refractory ceramic constructions elements.

Such a sealing material must fulfil various requirements: it must allow a certain deformability to compensate, for example, thermal expansions and contractions of adjacent, especially refractory elements without loosing the sealing function. This is relevant for applications at constant temperature of use as well as for applications where temperature changes occur. Further the sealing material must keep its shape over a certain time period and it must be refractory itself. Preferably it should be replaceable/renewable.

These requirements contradict at least partially from a technical point of view. Insofar it has been tried again and again to find a compromise between a deformability on the one hand and a resistance to temperature changes on the other hand.

It is know from practice to use refractory ceramic mortars (concretes) as a sealing material. But these get brittle after a certain time and undergo a considerable wear. A further disadvantage is that the sealing mortar adheres to the adjacent refractory element and/or both sinter together. This makes a disassembling and a replacement of such element and sealing more difficult.

Again from practice sealings made of glass fibres, rock fibres or ceramic fibres are known, wherein the fibres are fixed by a binder which often is not temperature resistant so that these sealings loose their shape stability especially at higher temperatures.

DE 10 2007 037 873 A1 describes a sealing made of an extrusion molded ceramic mass and a C-carrier with 15-45M-% carbon, wherein the sealing is tailored in a carbon envelope.

Accordingly it is the object of the invention to provide a sealing for high temperature applications, which avoids the disadvantages of prior art.

The inventive idea is based on the following concept.

There are great advantages in technical appliances if the sealing is provided “ready to use”. In other words: The sealing should be prepared in such a way that it can be used without further preparation/treatment. Insofar the sealing should have a deformability in such a way that it takes the shape of corresponding construction elements during assembly as far as possible. In other words: The sealing should be deformable in such a way that it may fulfil its sealing function to its best. Insofar the sealing mass (material) is prepared, for example, in a wet state and/or tailored in an envelope being tight against fluids. The fluid may be water which was used in preparing the mixture, a fluid binder, a fluid additive or the like. The fluid may as well be crystal water from the refractory components of the mass (monolithic) which will be freed under heat. The envelope avoids that air gets in contact with the sealing mass or avoids respectively that the wet ceramic mass dries, hardens or becomes brittle. By selection of the type and amount of said fluid the deformability may be adjusted specifically according to its appliance.

The shape of the scaling and the amount of the sealing mass may be adjusted exactly for each case of use. This allows to arrange a defined distance (joint) between two construction elements. To fill such gaps no special tools being necessary.

According to the invention the envelope (jacket) has a further important task, namely to disintegrate (fuming off) during use (under temperature load) at least partially, wherein the remainder of disintegration, especially carbon, provides a separating agent which avoids or at least reduces an undesired strong adhesion of the sealing mass at the corresponding construction element. Further undesired sintering between sealing mass and construction element is avoided by said separating agent (the separating layer). The sealing mass may deform independently in the desired way after breakup of the envelope to achieve a sealing at a refractory ceramic construction element or between such an element and a further element. Around the surface area of the sealing material temperatures between 1.500 and 1.700° C. prevail during a typical application between refractory ceramic workpieces of a metallurgical melting vessel during steel production. Depending on the distance to the steel melt the temperatures, to which the sealing material is exposed, become lower, down to 200° C. The sealing may fulfil its sealing function despite this large temperature interval.

Accordingly the high temperature sealing is featured as follows: It comprises a ceramic refractory sealing mass and an envelope surrounding the said refractory sealing mass, wherein the envelope decomposes (disintegrates) at temperatures between >50 and <2.000° C., thereby forming a carbon layer along the surface of the ceramic sealing mass.

The carbon layer may consist of subareas, for example, if only parts of the envelope are made of a material that provides the desired carbon based separating layer. Depending on the type and material of the envelope the separating layer may be designed thicker or thinner. This can be selected depending on the type of use (application).

In order to arrange the sealing at a corresponding construction element, for example a refractory ceramic element like a nozzle, it is advantageous, to stick/glue the sealing down. For this purpose the envelope comprises adhesive areas at least partially along its outer surface, which are preferably made of an adhesive, which comprises carbon as well. During use (for example, when a metal melt flows through the nozzle), i.e. after a considerable temperature increase compared with room temperature, the adhesive becomes as well disintegrated (the adhesive function is no loner relevant, as the sealing was placed before) and additional separating agent as carbon is released, which accrues as well in the surface region of the sealing material and avoids an undesired sintering between construction element and sealing.

The adhesive areas may be provided by double-sided adhesive strips, comprising a detachable protection foil at its outer surface. Such adhesive strips (tapes) may be easily attached onto the envelope.

A suitable wrapping material for the envelope are synthetics, for example of the group comprising: polyvinyl chloride (PVC), polyurethane (PU), polyethylene (PE), polypropylene (PP), polystyrene, polycarbonate, polyester, polyactic, polyethylene terephtalate (PET), cellulose hydrate, cellulose acetate, polyaerylate, caoutchouc, rubber, starch blend or the like. The envelope may be completely or partially of a plastic material.

The envelope may be provided by a one- or multi-layer foil. Individual or all layers may be made of plastics. Composite materials including further materials (besides plastics) such as paper (including coated, impregnated papers) are possible. The shape of the envelope (jacket) depends on the specific use. Examples are: pillow, collar, scarf, plate, pipe, cone, ring.

If for example a cylindrical outer surface of a refractory ceramic pipe is to be sealed against construction elements, in which the pipe is placed, the sealing may be designed as a cylindrical collar. The collar may be double walled, wherein the sealing material, for example made of a refractory component and an SiO₂ comprising component being arranged in a viscous state between an inner and an outer sheath. The collar may be deformed up to a certain degree and may he fittingly arranged onto said pipe.

In an analogous manner sealing areas of sliding plates, refractory ceramic pouring nozzles, gas purging plugs etc. may be sealed.

An exemplary composition of the sealing mass comprises (all in wt.-%):
tabular alumina (<0,3 mm): 34
corundum (<0,2 mm): 38
chromium oxide (<0,2 mm): 4
clay: 6
binder (monoaluminiumphosphate): 13
water: 5
sum: 100

The refractory sealing mass may further comprise carbon, but as a batch component, especially elementary carbon, for example as carbon black, graphite or the like.

Another suitable sealing mass comprises:
30 to 70 M.-% granular refractory components
70 to 30 M.-% of an SiO₂ comprising component, which is mostly stable in a temperature range up to about 100° C. and which decomposes/disintegrates at least partially at temperatures >100° C. while forming free SiO₂.

The SiO₂ comprising component may be a material from the group: silicone oil, silicone resin, silicon rubber.

The SiO₂ containing component is more or less stable in the low temperature range (for example at room temperature but as well at temperatures up to ca. 100° C.). But is gives the scaling material a certain deformability when mixed with the refractory granular sealing component. At higher temperatures this component disintegrates and forms free SiO₂. The free SiO₂ itself provides refractory performances and supports the stability of the sealing material in a high temperature range.

The SiO₂ containing component may be mixed with a granular refractory component to achieve a suspension in viscous form. This leads to a good deformability of the sealing material.

In the high temperature range the deformability gets lost at least partially, i.e. parallel to the decomposition of the SiO₂ containing component but without losing the sealing function.

The solid parts of the refractory sealing mass may be present in a grain fraction d₅₀<250 μm.

The refractory sealing mass may be principally composed of any material being refractory when used and comprises for example at least one refractory component selected from the group: silica, aluminosilicate, magnesia, MA-spinel, doloma, mullite, alumina, corundum, bauxite, zirconia, zirconia mullite, zirconia alumina, carbon, chromium oxide. By adding additives like clay, fluid binders and/or water the brittle and generally non-deformable refractory components may be prepared into a deformable sealing mass, wherein this deformability is secured by the fluid tight envelope until the envelope becomes disturbed.

This decomposition may be achieved by a thermal disintegration of the plastic material at a corresponding temperature level. The thus formed carbon residue then provides the desired separating agent.

Further features of the invention derive from the features of the sub-claims as well as the other application documents.

The invention is described hereinafter in more detail in connection with various embodiments.

In this context

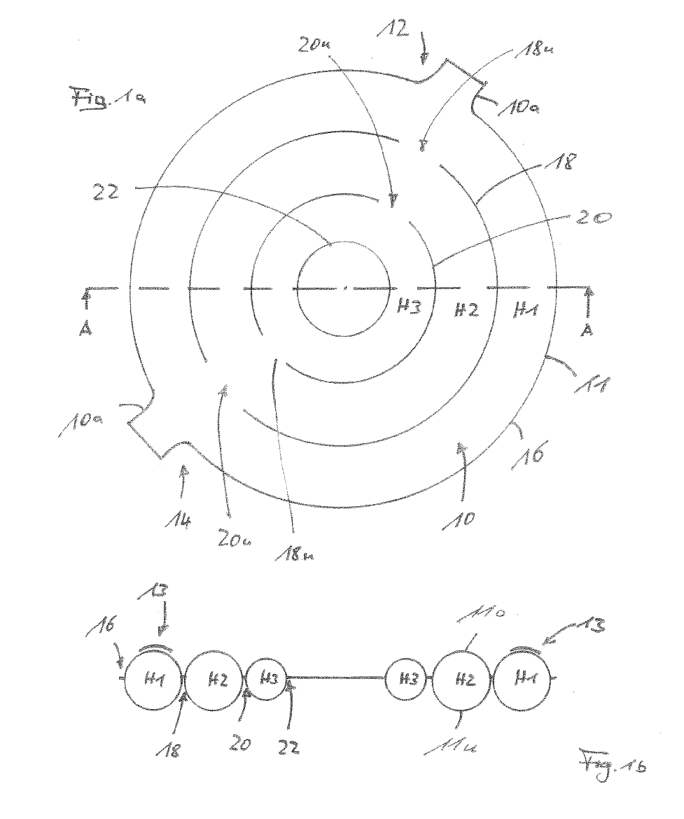

FIG. 1 shows a view onto a sealing in accordance with the invention and shaped as a circular pillow

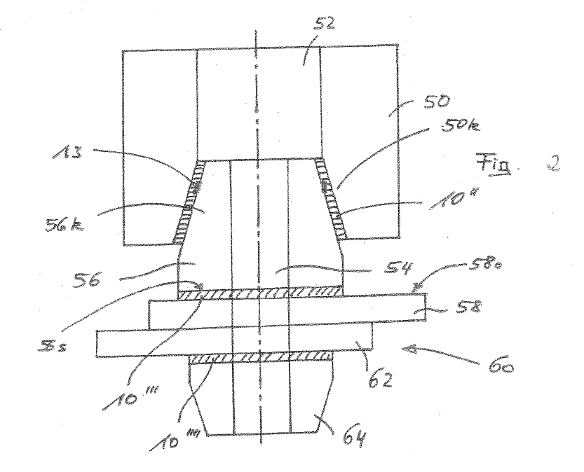

FIG. 2 is a sectional view according to A-A in FIG. 1

FIG. 3 is a longitudinal cut along a slide gate valve of a metallurgical ladle all in a schematic illustration.

In the Figures identical construction elements or construction elements providing similar effects are represented, at least partially, by same numerals.

FIG. 1a shows a sealing 10 shaped as a circular pillow (seen from above). The sealing comprises a plastic foil 11 made of two layers 11u, 11o, wherein each layer has about a circular shape. At their respective periphery the lower foil 11u and the upper foil 11o have neck-like extensions 10a at opposing sections (at 12,14).

Apart from their extensions 10a the said foils 11u, 11o are welded at their periphery, thus forming a surrounding welded joint 16, which is interrupted only in the area of said extensions 10a. Correspondingly the said extensions 10a provide an inlet and an outlet opening for filling a sealing material into the space between foils 11u, 11o.

Largely concentric to the circumferential welding seam 16 there arc more welded joints 18, 20, 22 arranged offset inwardly and at a distance. The welded joints 18,20 are interrupted at opposing sections (at 18u, 20u) like the circumferential welded joint 16, while inner welded seam 16 has a continuous circular shape.

The sealing of FIG. 1 is filled with a sealing material, made of an aqueous suspension comprising 50 M.-% of a finely divided chamotte/fire clay (d₅₀>250 μm) and 50 M.-% silicone resin. It was filled in via extension 10a at 12 and distributed within the circular spaces between welded joints 16, 18, 20, 22 until the hollow spaces H1, H2 and H3, ring shaped in a sectional view as shown in FIG. 1b, were more or less completely filled with the sealing material. Thereafter said foils 11u, 11o were welded together at their extensions 10a in order to jacket the sealing material completely in its final shape between foils 11lu, 11o.

The outlet area of a metallurgical ladle, shown in FIG. 2 comprises a well block 50 with a central through opening 52, followed by a flow through channel 54 of a nozzle 56, abutting with its conical part 56k on a sealing 10″ in accordance with the invention while the latter abutting against the corresponding inner conical section 50k of said well nozzle 50.

A further sealing 10″′ according to the invention is placed between a lower end-surface 56s of nozzle 56 and the upper side 58o of a sliding plate 58 of a slide gate valve, in total characterized by numeral 60.

While the sealing 10″ of FIG. 2 has the shape of a collar sealing 10″′ sealing 10″ of FIG. 2 is pillow shaped, similar to sealing 10 of FIG. 1, but here as a ring, including a central opening, corresponding to the flow through channel 54 of nozzle 56.

A corresponding sealing 10″″ is arranged between a lower slide plate 62 and an outlet nozzle 64.

The scalings according to FIG. 2 are made of a sealing mass based on tubular alumina, clay, monoaluminiumphosphate as disclosed in the general part of the description.

With all sealings the sealing mass/mixture is tailored within an envelope made of a plastic foil 11 which is fluid tight to the greatest possible extent. “Greatest possible extent” means, that the moisture/wetness in the scaling mass is kept over several weeks/months when it is stored correctly. Insofar these sealings may be inserted by the operator “ready to use”, as well in the medium-term and—if applicable—without further actions.

They are arranged then at or between adjacent refractory construction elements in the way described. During use, i.e. for example, when steel flows through the adjacent refractory construction element, the temperature around the sealing increases correspondingly while the plastic envelope pyrolyses and forms a carbon residue, which accumulates at the surface area of the ceramic sealing material and provides the function of a separating agent between said sealing mass and said adjacent refractory construction element or an adjacent metallic element respectively.

From this is derives that for example sealing 10″ according to FIG. 2 may be peeled off easily from well nozzle 50 and nozzle 56 when nozzle 56 is exchanged as the sealing mass does not sinter or sinters only to little extent with adjacent refractory elements.

To achieve an exact positioning of a sealing element at a corresponding construction element an adhesive layer is applied to the envelope (plastic foil 11) at least partially, as schematically shown in FIG. 1b by reference numeral 13. This is a double sided adhesive tape which is sticked with its one side onto said plastic foil 11 and fixed via its other side at the adjacent construction element. The adhesive tape is provided with a cover foil at its outer side which may be drawn off when bonding starts.

FIG. 2 shows the position of an analogeous ring shaped adhesive tape (numeral 13) for sealing 10″, again schematically.

1. High temperature sealing, including the following features:
1.1 a ceramic refractory sealing mass,
1.2 an envelope surrounding the said refractory sealing mass,
1.2.1 the envelope decomposes at temperatures between >50 and <2.000° C. and
1.2.2 forms a carbon layer, after its decomposition, along the surface of the ceramic sealing mass,
1.3 the envelope provides at its outer surface at least partially adhesive areas based on a carbon-containing adhesive.

2. High temperature sealing according to claim 1, the envelope of which being fluid tight.

3. High temperature sealing according to claim 1, the envelope of which is made of at least one material of the group comprising: silicone caoutchouc, silicon rubber, natural rubber, polyurethane, polyethylene, polypropylene, polycarbonate, polyethylene terephtalate.

4. High temperature sealing according to claim 1, the envelope is-of which is multi-layered.

5. (canceled)

6. High temperature sealing according to claim 1, the adhesive areas of which are provided by an adhesive tape (13) with a detachable protective cover foil.

7. High temperature sealing according to claim 1, the refractory sealing mass being made of:
7.1 30 to 70 M.-% of a granular refractory component and
7.2 70 to 30 M.-% of an SiO₂ comprising component, which is mostly stable in a temperature range up to about 100° C. and which disintegrates at least partially at temperatures >100° C. while forming free SiO₂.

8. High temperature sealing according to claim 7, the SiO₂ comprising component of which being a material from the group: silicone oil, silicone resin, silicon rubber.

9. High temperature sealing according to claim 1, solid parts of the refractory sealing mass of which being present in a grain fraction d₅₀<250 μm.

10. High temperature sealing according to claim 1, the refractory component of which comprises at least one refractory component of the group comprising: magnesia, doloma, alumina, bauxite, zirconia, carbon, chromium oxide, corundum.

11. High temperature sealing according to claim 1, the envelope of which has one of the following shapes: pillow, collar, scarf, plate, pipe, cone, ring.
